(19) United States
(12) Patent Application Publication
(10) Pub. No.: US 2012/0063507 A1
(43) Pub. Date: Mar. 15, 2012

(54) SYSTEM AND METHOD FOR REMOTE PRESENTATION PROVISION

(75) Inventor: Jason C. Straub, Henderson, NV (US)

(73) Assignee: LIGHTSPEED VT LLC, Las Vegas, NV (US)

(21) Appl. No.: 13/206,952

(22) Filed: Aug. 10, 2011

Related U.S. Application Data
(63) Continuation of application No. PCT/US2011/024578, filed on Feb. 11, 2011.
(60) Provisional application No. 61/303,903, filed on Feb. 12, 2010.

(51) Int. Cl. H04N 7/12

(52) U.S. Cl. 375/240.01; 375/E07.026

(57) ABSTRACT

The present invention includes a method for delivering a composite video. A computing device requests a composite video configured to play on the computing device, wherein the composite video comprises at least two assets. The computing device receives information associated with the at least two assets, Based on the received information, the computing device determines characteristics associated with the at least two assets. The computing device measures its bandwidth capabilities. Based on the characteristics and the computing device bandwidth, the computing device calculates delivery requirements associated with each of the at least two assets. A video player buffer associated with the computing device receives the at least two assets. Based on the received information, the computing device assembles the at least two assets into the composite video. Based on the delivery requirements, the computing device configures the video player buffer, and the computing device plays the composite video.

### FIELD OF THE INVENTION

The present invention generally relates to a system and method for remote presentation provision, such as a system and method for providing virtual training via a communications network.

### DETAILED DESCRIPTION OF THE PREFERRED EMBODIMENTS OF THE PRESENT INVENTION

It is to be understood that the figures and descriptions of embodiments of the present invention have been simplified to illustrate elements/steps relevant for a clear understanding of the present invention, while eliminating, for the purpose of clarity, other elements/steps found or used in typical presentation, production, data delivery and/or computing systems, devices and processes. Those of ordinary skill in the art may recognize that other elements and/or steps are desirable and/or required in implementing embodiments of the present invention. However, because such elements and steps are well known in the art, and do not facilitate a better understanding of the present invention, a discussion of such elements/ steps is not provided herein.

Referring now to FIG. 1, there is shown a configuration of a system 100 according to an embodiment of the present invention. In certain embodiments of the present invention, system 100 is well-suited for performing and/or providing functionalities described herein.

System 100 generally includes a first class of computing devices 110 and a second class of computing devices 120. The groups may but need not be mutually exclusive. For example, one or more computing devices may be members of more that one of classes 110, 120. Generally, each of the computing devices of classes 110, 120 are communicatively interconnected with one another via at least one data compatible network 130, such as the global interconnection of computers and computer networks commonly referred to as the Internet, and/or other wireline and/or wireless telecommunications networks. In the illustrated embodiment of FIG. 1, the computing devices of class 110 are interconnected with the computing devices of class 120 via network 130 and network connections 140. In certain embodiments of the present invention, one or more of these computing device interconnections may take the form of wireline and/or wireless Internet or other data network connections.

In certain embodiments of the present invention, class 110 computing devices may generally take the form of end-user computing devices, such as personal computers, like desktop, laptop and/or tablet computers, terminals, web enabled personal digital assistants, Internet appliances and/or web enabled cellular telephones or smart phones, for example.

In certain embodiments of the present invention, class 120 computing devices may generally take the form of servers, for example. In certain embodiments of the present invention, class 120 computing devices may correspond to network or system servers. In certain embodiments of the present invention, computing devices in class 120 provide one or more websites that are accessible by computing devices in class 110, for example.

By way of non-limiting explanation, “computing device”, as used herein, generally refers to a general purpose computing device that includes a processor. A processor, such as a microprocessor, as used herein, generally includes a Central Processing Unit (CPU). A CPU generally includes an arithmetic logic unit (ALU), which performs arithmetic and logical operations, and a control unit, which extracts instructions (e.g., code) from a computer readable medium, such as a tangible memory, and decodes and executes them, calling on the ALU when necessary. “Memory”, as used herein, generally refers to one or more devices or media capable of storing data, such as in the form of chips or drives. For example, memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including the processor. Memory may take the form of magnetic or optical technology based storage media. Memory may be internal or external to a computing device. Memory may store a computer program, e.g., code or a sequence of instructions being operable by the processor. In certain embodiments of the present invention, one or more elements may take the form of, or functionalities discussed may be provided using, code being executed using one or more computing devices, such as in the form of computing device executable programs or applications being stored in memory There are various types of computing devices, having varying processing and memory capabilities, such as: personal computers (like those that are commercially available from Dell and Apple Corp.), and personal digital assistants and smart phones (like those that are commercially available from Apple Corp., Motorola, HTC and Research in Motion), by way of non-limiting example only.

A “server”, as used herein, is generally communicatively coupled to a network, and manages network resources. A server may refer to a discrete computing device, or may refer to an application that is managing resources rather than a discrete computing device. “Network”, as used herein, generally refers to a group of two or more computing devices communicatively connected to one-another.

“Website”, as used herein, generally refers to a collection of one or more electronic documents (e.g., webpages) that are available via a computer and/or data compatible network, such as the Internet. By way of non-limiting example, a website may typically be accessed at a given address on the World Wide Web (e.g., “www.URL.TLD”), and include a home page, which is the first webpage visitors typically see when they enter the site. A website may also contain additional webpages. Webpages may be fixed, and/or dynamically generated in response to website visitor webpage requests. By way of further non-limiting example only, the World Wide Web is a system of Internet servers that generally support HTML (Hypertext Markup Language), such that a website visitor can jump from one webpage to another webpage by clicking on references to other webpages, such as hot spots or hot links (sometimes referred to as “links”). Web browsing applications, such as Microsoft's Internet Explorer, Google's Chrome, and Apple's Safari are commercially available applications typically used to access websites on the World Wide Web. Webpages are typically served by servers. Other computer network types and/or protocols and/or mark up languages and/or applications may be used.

Web browser applications, as referred to herein, may include one or more plug-ins. A plug-in, or add-on, as used herein, is a computer program (e.g., code stored in memory) that interacts with a host application (such as the web browser application) to provide a certain, often specific, function “on demand”. For example, a plug-in may be used to provide for media file playback within or in association with a host web browser application responsively to certain activity that occurs in connection with the host web browser application, e.g., a user clicking on a link.

Certain embodiments of the present invention may be used to provide for virtual training. By way of non-limiting example, virtual training may be used to teach general or specific knowledge, skills, and/or competencies in a simulated virtual environment. For example, virtual training can be used to provide one or more users with rich content, video presentations via one or more webpages. In certain embodiments of the present invention, these presentations may be interactive in nature, such that user interaction with the webpage or video presentation alters the course of presentation of the composite video presentations, akin to a “choose your own adventure”—type storyline. For example, user responses to inquiries presented via a video presentation or associated webpage (and/or a lack thereof) may be used to determine which presentation should be played next as part of the virtual learning or even a virtual testing environment and/or process.

Referring now to FIG. 2, there is shown an embodiment of a webpage 200 according to an embodiment of the present invention. Webpage 200 may include one or more video presentations 210, According to embodiments of the present invention, the one or more presentations 210 may each take the form of a composite video presentation. In the illustrated embodiment of Fig, 2, video presentation 210 includes a video component or asset 220, a background component or asset 230 and two auxiliary or support components or assets 242, 244.

Asset 220 generally takes the form of a digital audio/visual component (e.g., a digitized or digitally captured audio/video component in the form of a video file or data). Asset 230 generally takes the form of a background graphic component (e.g., an image file or data). Asset 230 may take the form of a static or dynamic in nature graphic (e.g., a static or dynamic image file or data). Assets 242, 244 may take the faun of auxiliary components, such as text and/or image components (e.g., text and/or an image files or data). According to certain embodiments of the present invention, when combined in accordance with a timeline, such assets may provide a composite video presentation that provides for a rich virtual training or learning environment.

Assets 220, 230, 242, 244 may be presented in varying positions, sizes and times to form and present a composite video presentation, For example, and referring now to FIG. 3, there is shown an exemplary timeline 300 that may correspond to the presentation of assets 220, 230, 242, 244 to a user as part of a video presentation via a webpage. In the illustrated embodiment of FIG. 3, the video presentation begins at time t0 and ends at time tx. Asset 220 is presented beginning at time t220in and ending at time t220out. Asset 230 is presented beginning at time t230in and ending at time tx. Asset 242 is presented beginning at time t242in and ending at time t242out. Asset 244 is presented beginning at time t2441n and ending at time t244out. The exemplary timeline of FIG. 3 is by way of non-limiting example only.

Such composite video presentations may typically require comprehensive video production services, which may include scripting, acting, recording and editing services, Conventionally, the production of such a composite video presentation combines the assets to be included to provide a single, common video file that may be presented using a media file player, such as Windows Media Player from Microsoft, Corp. The utilized production services may represent a substantial investment in terms of time and money to complete such a composite video presentation media file. Accordingly, should any of the assets need to be changed or be desired to be updated, substantial cost in reproducing the common media file may be involved.

Further, there are typically stringent data delivery requirements associated with effectively displaying video assets (e.g., asset 220), for example. Substantial costs may be involved with providing servers well-suited to meet these requirements. For example, third party data delivery solutions, such as those provided by Akamai, may be used. However, the delivery requirements of others of the assets, such as the auxiliary assets 242, 244, for example, may not be so stringent Accordingly, unnecessary resources and/or costs may typically be expended delivering the less resource intensive components of a composite video presentation media file.

Referring now to FIG. 4, there is shown a block diagrammatic view of a delivery of video presentation 210 according to certain embodiments of the present invention. In certain embodiments of the present invention, at least two assets of a composite video presentation may be delivered separately from one another, as opposed to being integrated into a common media file to be played, for example. In the embodiment of FIG. 4, each of the assets 220, 230, 242 and 244 are separately delivered for combination and playback at a user's computing device (e.g, 110, FIG. 1).

According to certain embodiments of the present invention, instructions for acquiring and assembling the relevant assets into a composite video presentation may also be provided for use at a user's web browser. In certain embodiments of the present invention, such instructions may be provide separate from at least one of the assets. In the embodiment of FIG. 4, instructions 410 are provided separately from each of the assets 220, 230, 242 and 244. In certain embodiments of the present invention, provided instructions may indicate a listing of relevant assets, other information related to the relevant assets (e.g., type of asset, size of asset file), information indicative of a timeline instructing when the relevant assets are to be included in and/or removed from the composite video presentation, and information indicative of an asset mapping showing where in the composite video playback (e.g., where in a playback window) assets are to be used.

Referring now to FIG. 5, there is shown a block diagrammatic view of a process 500 according to an embodiment of the present invention. Process 500 commences with launching a player application at a user's computing device at block 505. Such an application may take the form of a web browser plug-in, for example. Launching at block 505 may include executing computer executable code stored in memory corresponding to a web browser plug-in for playing a composite video presentation. Launching at block 505 may be commenced upon launching of the corresponding web browser application at the user's computing device, or the loading of a corresponding web page into a corresponding browser at the user's computing device, for example. Launching at block 505 may be commenced responsively to a user's interaction with a loaded web page using a browser at the user's computing device, for example. By way of further, non-limiting example, the player may be launched at block 505 responsively to a user activating a link corresponding to a request to play one or more composite video presentations. By way of further, non-limiting example, the player launched at block 505 may be used to allow a user to commence or progress through one or a series of composite video presentations corresponding to virtual training on a particular topic.

Referring still to FIG. 5, parameters may be identified at block 510. Parameter identification at block 510 may include identifying parameters associated with a user of the user's computing device, such as a user's permissions, for example. Processing at block 510 may include a user providing identification and/or authorization (e.g., user name/password) information, Parameter identification at block 510 may include identifying parameters associated with what composite video presentation should be then played-back Processing at block 510 may include identifying the composite video presentation that should be then played-back based on a user selection and/or progression along a virtual training program, for example. Parameter identification at block 510 may include identifying user permissions, based upon the user's identity and settings, for example. By way of further non-limiting example, processing at block 510 may include determining whether a user should have the ability to fast forward, rewind or even skip all or a portion of a composite video presentation, for example. Such a control may be particularly useful in a virtual training application, where certain members/users should be permitted to fast-forward through parts or all of a presentation (e.g., trainers), but other users shouldn't (e.g., trainees). Such a control may be particularly useful in a virtual training application, where certain members/users should be permitted to skip through parts or all of a presentation (e.g., users that have already successfully completed a corresponding portion of a virtual training program), but other users shouldn't (e.g, users that have not yet successfully completed a corresponding portion of a virtual training program).

Parameter identification at block 510 may be commenced responsively to a user's interaction with a loaded web page using a browser at the user's computing device, for example. By way of further, non-limiting example, parameters may be identified at block 510 responsively to a user activating a link (e.g, 212, FIG. 4) corresponding to a request to play one or more composite video presentations. By way of further, non-limiting example, parameters may be identified at block 510 based upon a user commencing or progressing through one or a series of composite video presentations corresponding to virtual training on a particular topic, and/or user provided information (e.g., user name/password), for example.

Player playback controls may be set at block 515. According to certain embodiments of the present invention, control elements of a media player launched at block 505 may be set at block 515 consistently with parameters identified at block 510. For example, if a given user is determined not to have the ability to fast-forward through parts of a presentation, then processing at block 515 may include disabling a fast-forward data item, such as a button in the player and/or corresponding host web browsing application that causes a composite video presentation then being played-out to skip forward along a corresponding timeline (e.g., 214, FIG. 4).

Player instructions may be acquired at block 520. According to certain embodiments of the invention, instructions acquired at block 520 may take the form of and/or include instructions for acquiring and assembling relevant assets into a composite video presentation at the user's computing device. According to certain embodiments of the invention, instructions acquired at block 520 may take the fowl of and/or include instructions analogous to instructions 410 (FIG. 4). According to certain embodiments of the present invention, processing at block 520 may include requesting data, such as a data file, dependently upon parameter identification at block 510. For example, processing at block 510 may identify what composite video presentation is to be played., In such a case, processing at block 520 may include requesting an instruction file corresponding to that composite video presentation. Such a request may be transmitted from a user's computing device 110 to one or more servers 120 (FIG. 1). Processing at block 520 may further include receiving the instructions in the form of data or a data file, from servers 120 (FIG. 1), for example. Processing at block 520 may include parsing the received instructions to identify the assets corresponding to the composite video presentation to be played and a timeline corresponding to their use in the composite video presentation, analogous to that described above, for example.

Assets identified by the instructions acquired at block 520 and the timeline for their use may be analyzed at block 525, Processing at block 525 may include determining the size, number, sources and delivery requirements of the assets at the player, for example.

Referring now to FIG. 6, there is shown a block diagrammatic representation of a process 600 according to certain embodiments of the present invention. Process 600 may be suitable for use as at least part of processing at block 520 (FIG. 5). At block 610, it may be determined how many assets are used in the indicated composite video presentation, such as by considering the instructions acquired at block 520. At block 620, data amount (e.g., asset file size, and/or the playback duration) and/or delivery need (e.g., the time in the timeline when some or all of the asset data will be needed for composition) may be determined. Processing at block 620 may consider the asset and timeline information included in the instructions acquired at block 520.

Referring again to FIG. 5, the communications bandwidth available for asset delivery may be determined at block 530. In certain embodiments of the present invention, the communications bandwidth for asset delivery may be determined by determining or considering the communications bandwidth or speed available for use by the user's computer and available to the host browser application and/or instantiated player, for example.

Delivery requirements for the assets based upon the measured bandwidth availability may be determined at block 535. In certain embodiments of the present invention, it may be determined that all necessary assets must be delivered to the player buffer prior to playback commencing, In certain embodiments of the present invention, it may be determined that a given percentage of one or more of the assets be delivered to the player buffer prior to playback commencing. In certain embodiments of the present invention, adaptive buffering that considers asset parameters, delivery constraints and proposed usage in the corresponding timeline may be used to determine a given percentage of one or more of the assets be delivered to the player buffer prior to playback commencing.

Referring still to FIG. 5, the relevant assets may be requested at block 540. In certain embodiments of the present invention, one or more of the assets identified at block 520 may be requested at block 540. For example, where one or more of the assets are identified as being deliverable by one or more of the servers 120 (FIG. 1) to the user's computer 110 (FIG. 1), request(s) for delivery of relevant data, e.g., asset files, may be sent from requesting computing device(s) 110 via network 130 to one or more of servers 120 at block 540. Server(s) 120 may respond by providing the requested assets via network 130 to the requesting computing device(s) 110.

One or more receive buffers included in, associated with and/or accessible by the launched player application may be initialized, configured and/or operated at block 545. Processing at block 545 may include configuring a buffer in accordance with the delivery requirements calculated at block 535.

Referring now also to FIG. 7, there is shown a block diagrammatic view of a process 700 according to certain embodiments of the present invention. At block 710, assets are received at the player buffer in accordance with the requests made at block 540. The received assets are assembled at block 720 into a composite video production at the player in accordance with the instructions acquired at block 520. Once the buffer(s) is/are determined to be sufficiently full at block 730 in accordance with the processing described above, processing returns to FIG. 5.

Referring again to FIG. 5, according to certain embodiments of the present invention, data received that satisfies the requests provided at block 540 may be provided to buffer(s), and the assembled composite video presentation read-out therefrom for playback by the player, in accordance with the configuration at block 545, at block 550.

Should an error in data delivery for playback (e.g., buffer loading, read-out and/or playback) be detected at block 555, processing may return to block 525, such that processing continues as discussed above, with regard to assets and/or portions of assets that have not yet been delivered to the buffer, for example.

It will be apparent to those skilled in the art that modifications and variations may be made in the systems and methods of the present invention without departing from the spirit or scope of the invention. It is intended that the present invention cover the modifications and variations of this invention provided they come within the scope of the appended claims and their equivalents.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and in which:

FIG. 1 illustrates a block diagrammatic representation of a system according to an embodiment of the present invention;

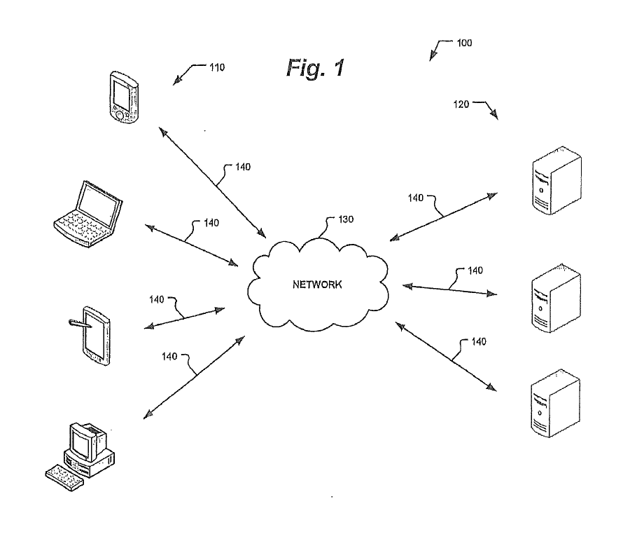

FIG. 2 illustrates a view of a webpage according to an embodiment of the present invention;

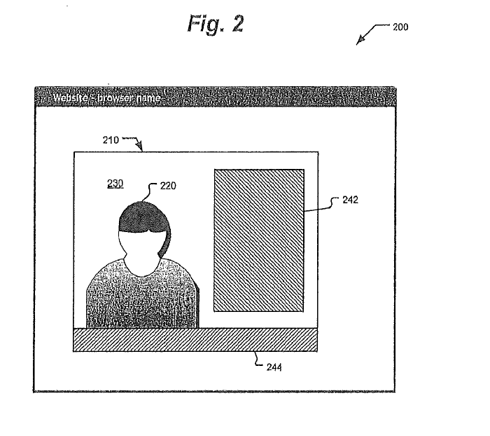

FIG. 3 illustrates a view of a timeline according to an embodiment of the present invention;

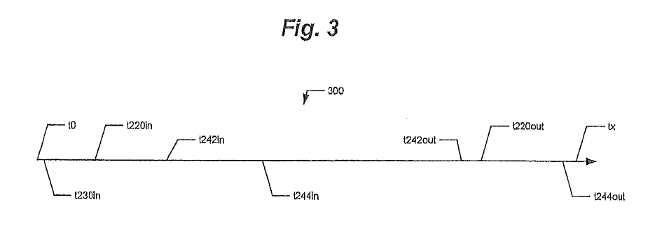

FIG. 4 illustrates a block diagrammatic view of delivery of a composite video presentation according to an embodiment of the present invention;

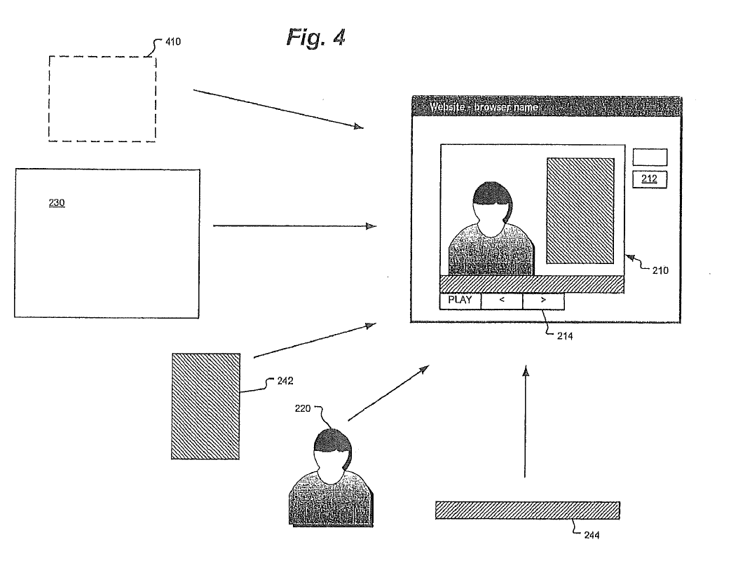

FIG. 5 illustrates a block diagrammatic view of a process according to an embodiment of the present invention;

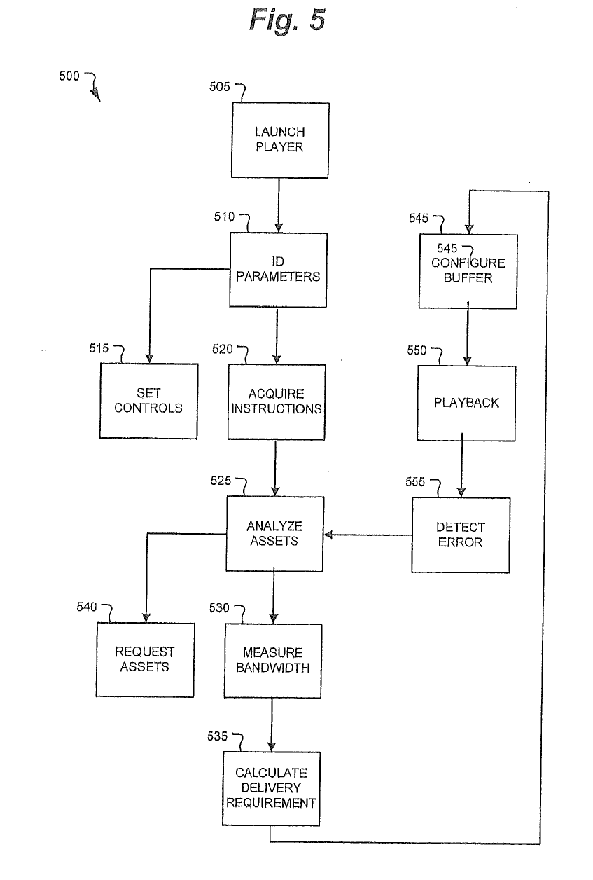

FIG. 6 illustrates a block diagrammatic representation of a process according to certain embodiments of the present invention; and

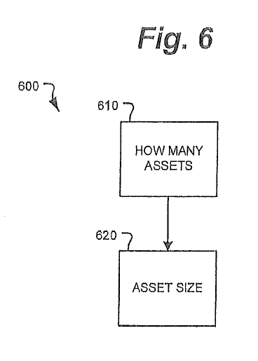

FIG. 7 a block diagrammatic view of a process according to certain embodiments of the present invention.

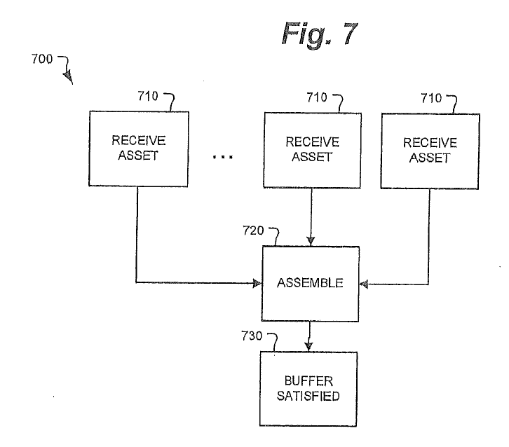

What is claimed is:

1. A method of transmitting a composite video over the internet through a buffering device, wherein the composite video comprises at least two assets comprising:
receiving at the buffering device information associated with the at least two assets;
based upon the received information, determining characteristics associated with the at least two assets; measuring available bandwidth of the internet, continuously calculating delivery requirements associated with each of the at least two assets based upon said characteristics and the available bandwidth, assembling the at least two assets into the composite video at the buffering device based upon the current delivery requirements, and continuously transmitting the assembled composite video in a manner that maximizes the quality of the transmission,

2. A non-transitory computer readable medium having instructions stored thereon, the instructions comprising: instructions for requesting, at a computing device, a composite video configured to play on a computing device, wherein the composite video comprises at least two assets; instructions for receiving, at the computing device, information associated with the at least two assets; based on the received information, instructions for determining characteristics associated with the at least two assets; instructions for measuring a bandwidth associated with the at least one computing device, based on the characteristics and the computing device bandwidth, instructions for calculating delivery requirements associated with each of the at least two assets; instructions for receiving, at a video player buffer associated with the computing device, the at least two assets; based on the received information, instructions for assembling the at least two assets into the composite video; based on the delivery requirements, instructions for configuring the video player buffer; and instructions for playing, at the computing device, the composite video.

3. A computing device for playing a composite video, the computing device configured to perform the steps of: requesting, from at a computing device, a composite video configured to play on a computing device, wherein the composite video comprises at least two assets; receiving, at the computing device, information associated with the at least two assets; based on the received information, determining characteristics associated with the at least two assets; measuring a bandwidth associated with the at least one computing device, based on the characteristics and the computing device bandwidth, calculating delivery requirements associated with each of the at least two assets; receiving, at a video player buffer associated with the computing device, the at least two assets; based on the received information, assembling, at the computing device, the at least two assets into the composite video; based on the delivery requirements, configuring the video player buffer; and playing, at the computing device, the composite video,
